(19) United States
(12) Patent Application Publication
(10) Pub. No.: US 2025/0320723 A1
(43) Pub. Date: Oct. 16, 2025

(54) CONSTRUCTION MATERIAL REINFORCEMENT LAYER WITH A DATA CARRIER

(71) Applicant: CARLISLE CONSTRUCTION MATERIALS GMBH, Waltershausen (DE)

(72) Inventor: Josef SOCHOR, Waltershausen (DE)

(73) Assignee: CARLISLE CONSTRUCTION MATERIALS GMBH, Waltershausen (DE)

(21) Appl. No.: 18/868,119

(22) PCT Filed: May 25, 2023
(86) PCT No.: PCT/EP2023/064134

§ 371 Date: Nov. 21, 2024

(30) Foreign Application Priority Data
May 25, 2022 (LU) LU102955

(51) Int. Cl. E04D 5/10; B32B 5/02; B32B 11/04; B32B 11/10

(52) U.S. Cl. CPC E04D 5/10; B32B 5/022; B32B 11/046; B32B 11/10; B32B 2419/06

(57) ABSTRACT

A construction material reinforcement layer comprises at least a reinforcement, wherein at least one data medium is connected to the reinforcement, wherein the at least one data medium is comprised by a thread, wherein the thread is connected to the reinforcement. A construction material comprises a construction material reinforcement layer comprising at least one data medium.

The present disclosure is in the field of construction materials and in particular in the field of smart construction materials and relates to a construction material reinforcement layer and construction materials comprising such a reinforcement.

Construction materials within the meaning of this application can be plaster grids, sealing membranes, vapor barrier membranes, gas membranes, geomembranes, concrete mastic asphalt layers, insulation (e.g. aluminium layer with mineral wool), formwork protection panels, sun protection, shading or insulating materials. There can be an optional top, bottom or double-sided lamination. Usually, construction material reinforcement layers and most construction materials have a longitudinal direction (i.e. stripe-shaped) (e.g. plaster grid or plaster reinforcement grid, rectangular insulation boards, insulation rolls, sealing or roofing membranes, etc.). Directions used here such as “longitudinal”, “transverse” or “diagonal” refer to such a longitudinal direction. Furthermore, such construction materials can be flat materials. Furthermore, construction material reinforcement layers (strength members) can be produced as endless material with a specific width and a longitudinal direction that is also the direction of production or removal (e.g. for plaster grids or roofing membranes).

With construction materials, identification can be difficult or even impossible, especially when installed and after a long period of time. For example, information about the batch and/or the installation date can be lost and lead to problems in warranty management, for example. It is also sometimes not possible to carry out a clear identification in a non-destructive manner. Documents EP2326766B1, U.S. Pat. Nos. 10,546,277B2 and 8,284,028B2 deal with roofing membranes with RFID tags.

It is therefore the object of the present invention to present a construction material reinforcement layer and construction materials comprising such a reinforcement layer, which enables digital identification and traceability even after a long period of time and in a non-destructive manner.

This task is solved by the attached independent claims.

According to an aspect of the present disclosure, a construction material reinforcement layer comprises at least one reinforcement. At least one data medium is connected to the reinforcement. The reinforcement may comprise at least one of a multiaxial reinforcement, at least one textile, fabric(s), scrim(s), nonwoven fabric(s) made of glass, carbon and aramid and/or laminates thereof. The reinforcement can also (in addition to exclusively) comprise fabrics based on polyester, PP, PE and/or tear-resistant material as well as scrim-nonwoven fabric, scrim mats and hybrid fabric or scrim. The at least one data medium is surrounded by a thread. The thread is connected to the reinforcement. This can have the advantage that the at least one or more data media can be processed and/or loaded with information more easily. The thread can comprise at least one of polyester, cotton, PP, PE, aramid and/or glass. It may also be advantageous that the required at least one antenna of the data medium can be attached along the thread. The attachment of the at least one data medium can, for example, be an application to the thread and/or an incorporation into the thread. This can have the advantage that a robust construction material reinforcement layer can be obtained that can be adapted to a wide variety of applications and whose at least one data medium can be read out.

The data media include RFID data media or any other suitable passive form of data medium that can be read over a distance. Preferably, the data media are as small as possible, but must be designed in such a way that they can withstand the manufacturing environment during the production of the construction material reinforcement layer or the construction materials (e.g. mechanical, thermal and chemical stresses) and do not result in any visible product defects that impair the function.

According to a further aspect of the present disclosure, the (construction material) reinforcing layer comprises at least one of nonwoven fabric and/or oriented scrim. This may have the advantage that the reinforcing layer can be adapted to the respective application.

According to a further aspect of the present disclosure, in a construction material reinforcement layer, the data medium is incorporated into the reinforcement. This can have the advantage that the processing of the construction material reinforcement layer or of the at least one data medium in a construction material is simplified.

According to a further aspect of the present disclosure, at least one of the data medium, the thread or the reinforcement comprises an impregnation. This may have the advantage that the data medium or thread is protected against at least one of capillary formation, chemical attack, mechanical stresses such as bending and compression or temperature effects.

According to a further aspect of the present disclosure, the thread is inserted into the directional scrim. This may have the advantage that the scrim can be processed more easily with the at least one data medium.

According to a further aspect of the present disclosure, the thread is inserted in the reinforcement or the directed scrim in at least one of the following directions with respect to a longitudinal direction of the reinforcing layer: transversely, longitudinally and/or diagonally. This can have the advantage that the arrangement can be adapted to the respective application.

According to a further aspect of the present disclosure, in a construction material reinforcement layer, the thread is inserted into scrim and into other scrim (e.g. unidirectional, bidirectional, biaxial, triaxial and quadraxial) that may be multiaxially oriented. The strength member can have different constructions and/or mesh sizes.

According to an aspect of the present disclosure, a construction material comprises a construction material reinforcement layer according to any of the above aspects. This may have the advantage that the construction material is stable and may have readable information.

According to an aspect of the present disclosure, the construction material comprises a layer comprising at least one of EPDM, butyl, PVC, EVA, FPO, TPE, PP, PE, PA or other elastomer and plastic layers. This can have the advantage that the construction material can be adapted to the respective application.

According to an aspect of the present disclosure, the construction material comprises a reinforcement layer and a layer with bitumen, wherein the layer with bitumen comprises the construction material reinforcement layer. This may have the advantage that the layer with bitumen and thus the construction material is stabilized. The reinforcement layer can be incorporated into the layer with bitumen. Then there is the additional advantage that the at least one data medium can be protected by the layer with bitumen.

According to an aspect of the present disclosure, the at least one layer or the at least one layer with bitumen comprises the construction material reinforcement layer.

According to an aspect of the present disclosure, the construction material comprises at least two layers of the layer and/or the layer with bitumen and the construction material reinforcement layer is arranged between the layers.

In other words, the construction material reinforcement layer can be arranged between the layers in a multi-layer structure of the construction material. Also, a plurality of construction material reinforcement layers may be included and these construction material reinforcement layers may be arranged between and/or within the layers. The foregoing applies to the entire disclosure.

According to one aspect of the present disclosure, a construction material comprises at least one lamination layer, wherein the lamination layer comprises the construction material reinforcement layer. This may have the advantage that the lamination with the construction material reinforcement layer is not subject to deformation, it has a dimension stabilizing effect, in particular under temperature and external mechanical stress.

According to one aspect of the present disclosure, a method of identifying construction material comprises the steps of:
Coding of a data medium with an identifier;
Assigning data in a database to the identifier;
Read out the identifier from the data medium;
Query the data from the database using the identifier.

This can have the advantage that no large amounts of data need to be stored on at least one data medium.

According to one aspect of the present disclosure, a method of identifying construction material comprises the steps of:
Attachment or insertion of at least one data medium to or into a construction material reinforcement layer;
Manufacture of a construction material comprising the construction material reinforcement layer;
   wherein the at least one data medium is encoded before or after one of the aforementioned steps.

This can have the advantage that an identifiable construction material can be produced and data can be read out directly. The necessary coding, programming or recording of the at least one data medium can take place before or after it is attached to or inserted into the construction material reinforcement layer. Alternatively, the at least one data medium can also be encoded after the construction material has been produced.

The aforementioned advantages and/or features of the invention need not be present simultaneously in all embodiments, but can be combined with one another as desired to form new embodiments. The features of the method claims can be adopted in the device claims and the two methods can be combined, for example via the coding step.

### BRIEF DESCRIPTION OF THE FIGURES

Further characteristics and advantages of the invention will become apparent in the course of the following description of its embodiments, which is given only by way of example and not by way of limitation in conjunction with the accompanying drawings. The figures show:

FIG. 1 is a schematic representation of an embodiment of the present application.

FIG. 2 is a schematic representation of a further embodiment of the present application.

FIG. 3 is a schematic representation of a further embodiment of the present application.

FIG. 4 is a schematic representation of a further embodiment of the present application.

FIG. 5 is a schematic representation of a further embodiment of the present application.

FIG. 6 is a schematic representation of a further embodiment of the present application.

FIG. 7 is a flow chart of a method according to one embodiment of the present application.

FIG. 8 is a flow chart of a method according to one embodiment of the present application.

By way of introduction, it should be noted that in the differently described embodiments, the same parts are provided with the same reference signs or the same component designations, whereby the disclosures contained in the entire description can be transferred analogously to the same parts with the same reference signs or the same component designations. The layer details selected in the description, such as top, bottom, side, etc., are also related to the directly described and illustrated figure and these layer details are to be transferred analogously to the new layer in the event of a layer change.

### DETAILED DESCRIPTION OF THE EMBODIMENTS

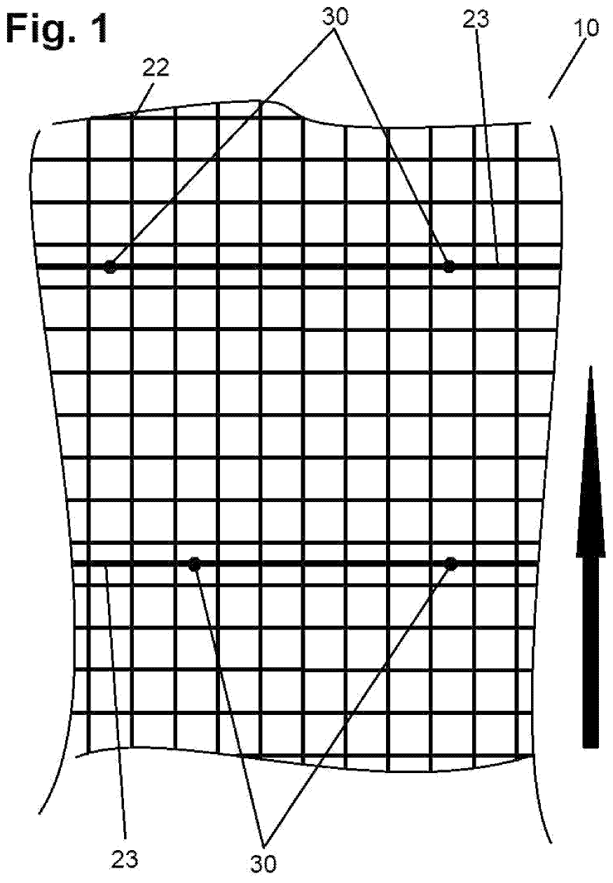

Reference is initially made to FIG. 1, which shows a section of a construction material reinforcement layer 10. In particular, a directional scrim 22 is shown, as is known from the reinforcement of roofing membranes, concrete layers, insulating material or plaster grids. Typically, a construction material reinforcement layer 10 has a longitudinal or take-off (removal) direction in which the construction material reinforcement layer 10 is produced as continuous material (shown by the arrow in FIGS. 1 to 3) and a transverse direction in which the extension is normally fixed (e.g. by the dimensions of the machinery). FIGS. 1 to 3 show any sections of construction material reinforcement layers 10 with directed scrim 22. However, the explanations for construction material reinforcement layers 10 with nonwoven fabric 21 apply mutatis mutandis.

The directed fabric comprises longitudinal threads (parallel to the direction of the arrow) and transverse threads (transverse to the direction of the arrow). In the embodiment shown, a plurality of data median 30 is comprised by a thread 23 (possibly including an impregnation 24). In the embodiment shown in FIG. 1, the thread 23 with the data media 30 runs parallel and between two transverse threads. Two threads 23 are shown as an example. If the construction material reinforcement layer 10 were a nonwoven fabric 21, the thread 23 would be applied in the transverse direction in and/or on the nonwoven fabric 21. The data medium 30 can also be connected directly to the construction material reinforcement layer 10. The thread 23 can also be inserted (e.g. woven) directly into the scrim 22 instead of one of the threads of the scrim 22. The distance between the data media 30 is arbitrary. The distance between the threads 23 (two shown) and the number of threads 23 in the construction material reinforcement layer 10 are arbitrary.

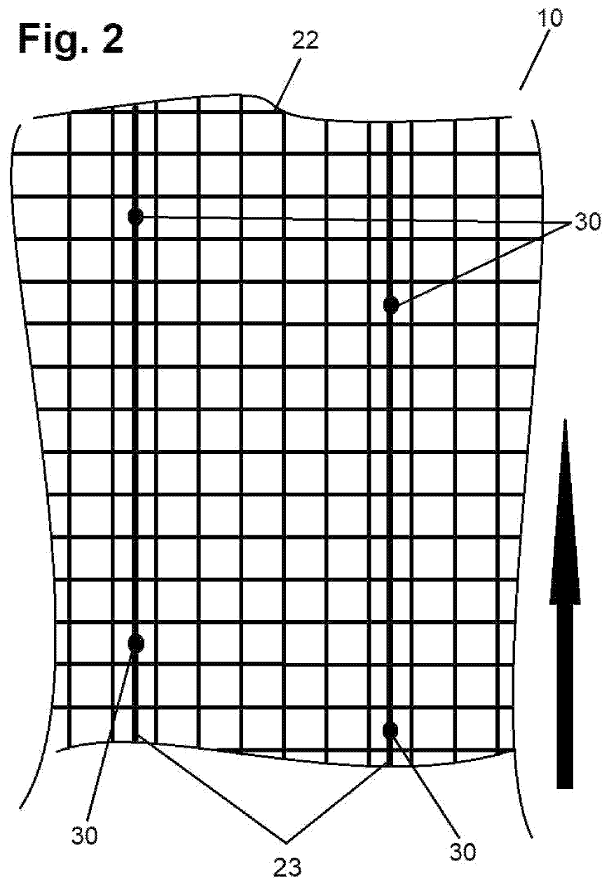

The embodiment shown in FIG. 2 is similar to the embodiment shown in FIG. 1. In contrast, the two threads 23 shown are arranged with the data media 30 parallel to the longitudinal direction (arrow) or the longitudinal threads. Here too, the threads 23 could be attached to and/or in a nonwoven fabric 21 if the construction material reinforcement layer 10 were to include this instead of the directional scrim 22 shown. In the embodiment of FIG. 2, the data medium 30 can also be connected directly to the construction material reinforcement layer 10. The thread 23 can also be inserted (e.g. woven) directly into the scrim 22 instead of one of the threads of the scrim 22. Any number of threads 23 is possible. Furthermore, any distance between the threads 23 and data medium 30 is possible.

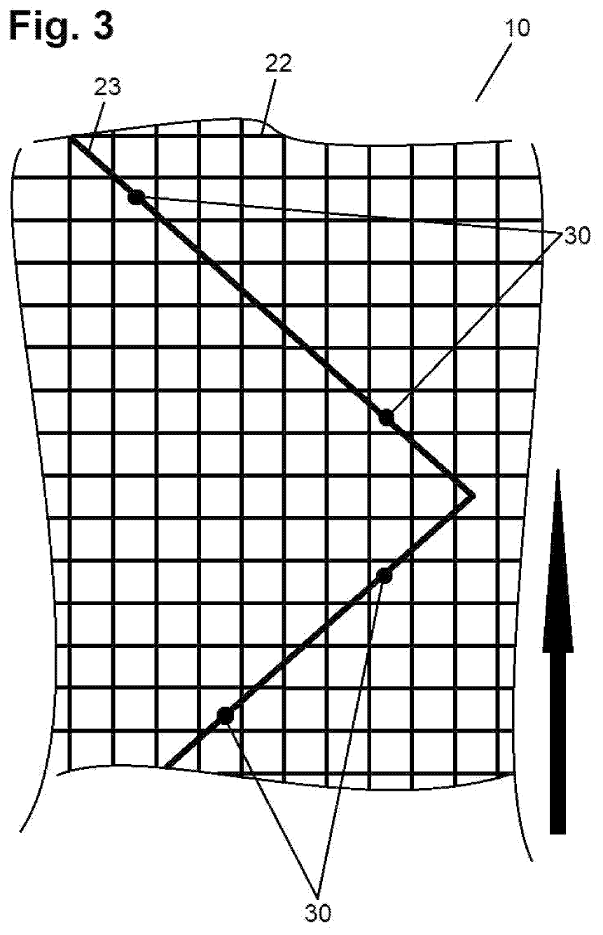

The embodiment in FIG. 3 is similar to the embodiments shown in FIGS. 1 and 2. In contrast to them, the thread 23 with the data media 30 runs in a zigzag in the longitudinal direction (direction of the arrow). This could also be in the transverse direction (transverse to the direction of the arrow) or in any other form (e.g. wavy). The thread 23 is shown continuous, but can also be segmented (not continuous).

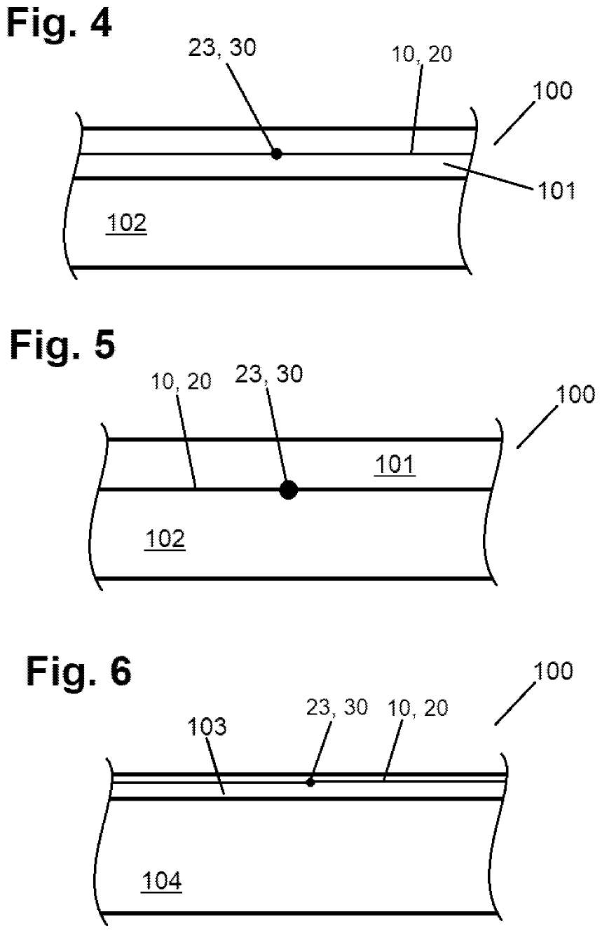

FIG. 4 shows a construction material 100 with a construction material reinforcement layer 10. The construction material reinforcement layer 10 comprises at least one data medium 30, which is attached to a thread 23. The construction material reinforcement layer 10 is embedded in a layer of bitumen 101. However, this can also be at least one of EPDM, butyl, PVC, EVA, FPO, TPE, PP, PE, PA or other elastomers or plastics. The layer bitumen 101 is applied to a layer 102, which may comprise at least one of EPDM, butyl, PVC, EVA, FPO, TPE, PP, PE, PA or other elastomers or plastics. The position of the construction material reinforcement layer 10 is shown in the center of the layer with bitumen 101. However, the position is arbitrary. It is preferable that the at least one data medium 30 is completely enclosed by the bitumen (or other material) in order to protect it from external influences (e.g. weathering).

FIG. 5 shows an embodiment similar to that in FIG. 4. The above material specifications for the layers shown are also applicable here. In the embodiment shown in FIG. 5, the construction material reinforcement layer 10 with the at least one data medium 30 is arranged on or in a thread 23 between the layer with bitumen 101 and the layer 102. There may also be two layers 102 (possibly made of different materials) or two layers with bitumen 101, with the construction material reinforcement layer 10 being arranged between the layers in each case.

FIG. 6 shows an embodiment of a construction material 100 comprising a lamination layer 103 and an insulation layer 104. The lamination layer 103 comprises the construction material reinforcement layer 10 with the at least one data medium which may be connected to a thread 23. The construction material reinforcement layer 10 can also be inserted between the lamination layer 103 and the insulation layer 104. The insulation layer 104 can comprise any known insulating material.

For all embodiments shown, the thread 23 with the at least one data medium 30 and/or at least one data medium 30 can be placed on the construction material reinforcement layer 10 during the production of a construction material 100, but can also already be placed with the construction material reinforcement layer 10, but can also already be connected to the construction material reinforcement layer 10 and then be fixed by the material surrounding the construction material reinforcement layer 10, which is subsequently applied. Any of the statements made in connection with FIGS. 1 to 3 can be applied to the embodiments of FIGS. 4 to 6. FIGS. 1 to 3 disclose directional scrim with rectangular meshes. The directional scrim can have any multiaxial mesh shape (e.g. hexagonal or octagonal and/or also unidirectional, bidirectional, biaxial, triaxial and quadraxial), 3D meshes are also possible.

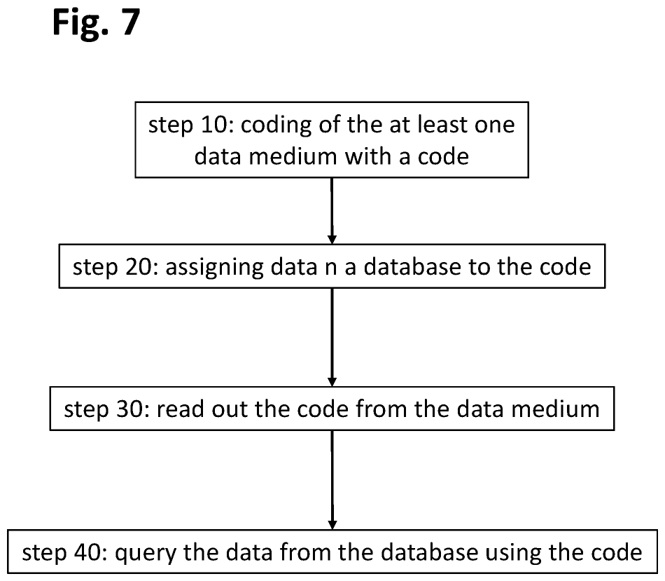

FIG. 7 shows a flow chart of a method for identifying construction material. The method comprises the following steps:
Coding of a data medium with an identifier (code);
Assigning data in a database to the identifier;
Read out the identifier from the data medium;
Query the data from the database using the identifier.

In the step of encoding the (at least) one data medium 30, the data medium is recorded with an identifier or code or the data medium is encoded. The identifier does not correspond to the data that may be of interest, such as date of manufacture, batch number, customer, installation date, etc.

In the step of assigning data in a database, (possibly several) data (e.g. date of manufacture, batch number, customer, installation date, customer, intermediary, installing company, etc.) are assigned to the identifier. Any amount of data can be assigned here without having to take into account the maximum storage space of the data medium 30.

In the step of reading the identifier, it is read from one or more data media. This can be done with all standard devices.

In the step of retrieving the data from the database, the read-out identifier is used to find the data stored there and display it to the user. This can be done, for example, via a suitable mobile device that has wireless communication. This allows the data to be evaluated or output directly on site (e.g. on the roof).

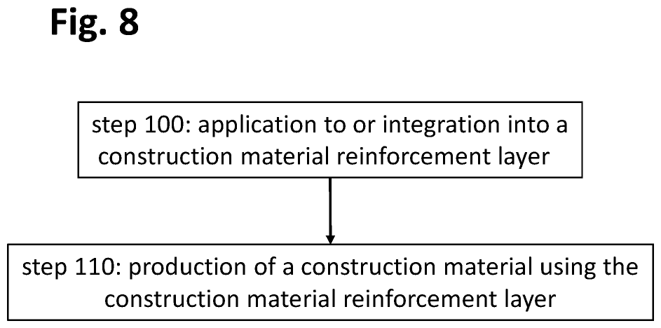

FIG. 8 shows a flow chart of a method for identifying construction material. The method comprises the following steps:
Coding of a data medium with an identifier (code);
Assigning data in a database to the identifier.
   wherein the at least one data medium is encoded before or after one of the aforementioned steps.

In step 100, a data medium is applied to or integrated into a construction material reinforcement layer. The at least one data medium can, for example, be attached in or to a (directional) reinforcement layer such as a fabric. Furthermore, the at least one data medium can also be attached in or to a non-directional reinforcement layer such as a non-woven fabric.

In step 110, a construction material (e.g. a sealing sheet, insulating material, etc., see above) is produced using the construction material reinforcement layer produced in step 100. The at least one data medium can be encoded or recorded with information before or after step 100. The at least one data medium can also be recorded when the construction material is produced.

### LIST OF REFERENCE SIGNS

10 construction material reinforcement layer
20 reinforcement
21 nonwoven fabric
22 directional scrim
23 thread
24 impregnation
30 data medium
100 construction material
101 layer with bitumen
102 layer
103 lamination layer
104 insulation layer

1. Construction material reinforcement layer (10) comprising at least one reinforcement (20), wherein at least one data medium (30) is connected to the reinforcement, wherein the at least one data medium (30) is surrounded by a thread (23), wherein the thread is connected to the reinforcement (20).

2. The construction material reinforcement layer (10) according to claim 1, wherein the reinforcement (20) comprises at least one of nonwoven fabric (21) and/or directional scrim (22).

3. Construction material reinforcement layer (10) according to claim 1, wherein the data medium is integrated into the reinforcement (20).

4. The construction material reinforcement layer (10) according to claim 1, wherein at least one of the data medium (30), the thread (23) or the reinforcement (20) comprises an impregnation.

5. Construction material reinforcement layer (10) according to claim 1, wherein the thread (23) is integrated into the directional scrim (22).

6. The construction material reinforcement layer (10) according to claim 3, wherein the thread (23) is inserted in the reinforcement (20) or the directional scrim (22) in at least one of the following directions with respect to a longitudinal direction of the construction material reinforcement layer: transversely, longitudinally and/or diagonally.

7. Construction material reinforcement layer (10) according to claim 3, wherein the inserted thread (23) is integrated into the scrim (22) and in multiaxially aligned scrim.

8. A construction material (100) comprising a construction material reinforcement layer (10) according to claim 1.

9. The construction material (100) according to claim 8, further comprising at least one layer (102) comprising at least one of EPDM, butyl, PVC, EVA, FPO, TPE, PP, PE, PA.

10. The construction material (100) according to claim 8, further comprising at least one layer with bitumen (101).

11. The construction material (100) according to claim 9, wherein the at least one layer (102) or the at least one layer with bitumen (101) comprises the construction material reinforcement layer (10).

12. The construction material (100) according to claim 9, wherein at least two layers are comprised by the layer (102) and/or the layer with bitumen (101) and the construction material reinforcement layer (10) is arranged between said layers.

13. The construction material (100) according to claim 8, further comprising at least one lamination layer (103), wherein the lamination layer comprises the construction material reinforcement layer (10).

14. The construction material (100) according to claim 8, further comprising an insulation layer (104), wherein the construction material reinforcement layer (10) may be arranged on or in the insulation layer (104).

15. A method of identifying construction material comprising the steps of:
coding of a data medium with an identifier;
assigning data in a database to the identifier;
reading out the identifier from the data medium;
querying the data from the database using the identifier.

16. A process for identifying construction material the steps:
attachment or insertion of at least one data medium to or into a construction material reinforcement layer;
manufacture of a construction material comprising the construction material reinforcement layer;
wherein the at least one data medium is encoded before or after one of the aforementioned steps.
